(19) United States
(12) Patent Application Publication
(10) Pub. No.: US 2005/0149536 A1
(43) Pub. Date: Jul. 7, 2005

(54) Data migration and format transformation system

(76) Inventors: Rick Wildes, Oviedo, FL (US); Robert Bonham, Ridley Park, PA (US)

Correspondence Address: Alexander J. Burke;Intellectual Property Department, 5th Floor, 170 Wood Avenue South, Iselin, NJ, 08830, US

(21) Appl. No.: 10/875,548

(22) Filed: Jun. 24, 2004

Related U.S. Application Data
(60) Provisional application No. 60/482,330, filed on Jun. 25, 2003.

(51) Int. Cl. G06F 7/00

(52) U.S. Cl. 707/100

(57) ABSTRACT

A system transforms data having a first data structure to data having a different second data structure that is compatible with an executable application. The system includes a conversion template and a conversion processor. The conversion template includes predetermined executable instructions for directing conversion of data source records having a first data format to data target records having a different second data format. The conversion processor maps and converts data elements in data fields of the data source records to data elements in corresponding data fields of the data target records by manipulating data element values and data field characteristics, in response to the conversion template.

### CROSS-REFERENCE TO RELATED APPLICATIONS

The present application is a non-provisional application of provisional application having Ser. No. 60/482,330 filed by Wildes, et al. on Jun. 25, 2003.

### FIELD OF THE INVENTION

The present invention generally relates to computer information systems. More particularly, the present invention relates to a data migration and format transformation system.

### BACKGROUND OF THE INVENTION

Computer information systems for healthcare enterprises and other enterprises sometimes need data stored as first data format for use in a first computer system to be migrated and converted to a second data format, different from the first data format, for use in a second computer system, different from the first computer system. Typically, custom, conversion software code is created to move and convert data from the first computer system to the second computer system.

Existing software applications and software tools move and convert data from one computer system to another. However, these existing applications and tools usually move data from operational databases to data warehouses and usually do not provide flexibility and customization desired.

In order to move and convert data to be compatible with a different computer system, software code is usually created and tested for each individual re-location and conversion project. In addition, the created code performing a conversion is typically for use by programmers and is not user friendly. The created code usually also does not provide a user interface enabling user to assess the progress of a conversion or to customize the conversion after testing the created code. Accordingly, there is a need for a data migration and format transformation system that overcomes these and other disadvantages of the prior systems.

### SUMMARY OF THE INVENTION

According to one aspect of the present invention, a system transforms data having a first data structure to data having a different second data structure that is compatible with an executable application. The system includes a conversion template and a conversion processor. The conversion template includes predetermined executable instructions for directing conversion of data source records having a first data format to data target records having a different second data format. The conversion processor maps and converts data elements in data fields of the data source records to data elements in corresponding data fields of the data target records by manipulating data element values and data field characteristics, in response to the conversion template.

### BRIEF DESCRIPTION OF THE DRAWINGS

FIG. 1 illustrates a data migration and format transformation system, in accordance with a preferred embodiment of the present invention.

FIG. 2 illustrates a functional block diagram of a conversion engine, for the system shown in FIG. 1, in accordance with the preferred embodiment of the present invention.

FIG. 3 illustrates a reader processor method, for the system and engine shown in FIGS. 1 and 2, respectively, in accordance with the preferred embodiment of the present invention.

FIG. 4 illustrates a mapper processor method, for the system and engine shown in FIGS. 1 and 2, respectively, in accordance with the preferred embodiment of the present invention.

FIG. 5 illustrates a writer processor method, for the system and engine shown in FIGS. 1 and 2, respectively, in accordance with the preferred embodiment of the present invention.

FIG. 6 illustrates a log-writer processor method, for the system and engine shown in FIGS. 1 and 2, respectively, in accordance with the preferred embodiment of the present invention.

FIG. 7 illustrates a conversion plan window, for the system and engine shown in FIGS. 1 and 2, respectively, in accordance with the preferred embodiment of the present invention.

FIG. 8 illustrates a conversion plan execution resource window, for the system and engine shown in FIGS. 1 and 2, respectively, in accordance with the preferred embodiment of the present invention.

FIG. 9 illustrates a field definition window, for the system and engine shown in FIGS. 1 and 2, respectively, in accordance with the preferred embodiment of the present invention.

FIG. 10 illustrates a field attribute window, for the system and engine shown in FIGS. 1 and 2, respectively, in accordance with the preferred embodiment of the present invention.

FIG. 11 illustrates a record properties dialog window, for the system and engine shown in FIGS. 1 and 2, respectively, in accordance with the preferred embodiment of the present invention.

FIG. 12 illustrates a processor list window, for the system and engine shown in FIGS. 1 and 2, respectively, in accordance with the preferred embodiment of the present invention.

FIG. 13 illustrates a processor properties window, for the system and engine shown in FIGS. 1 and 2, respectively, in accordance with the preferred embodiment of the present invention.

FIG. 14 illustrates a data source properties window, for the system and engine shown in FIGS. 1 and 2, respectively, in accordance with the preferred embodiment of the present invention.

### DETAILED DESCRIPTION OF THE PREFERRED EMBODIMENTS

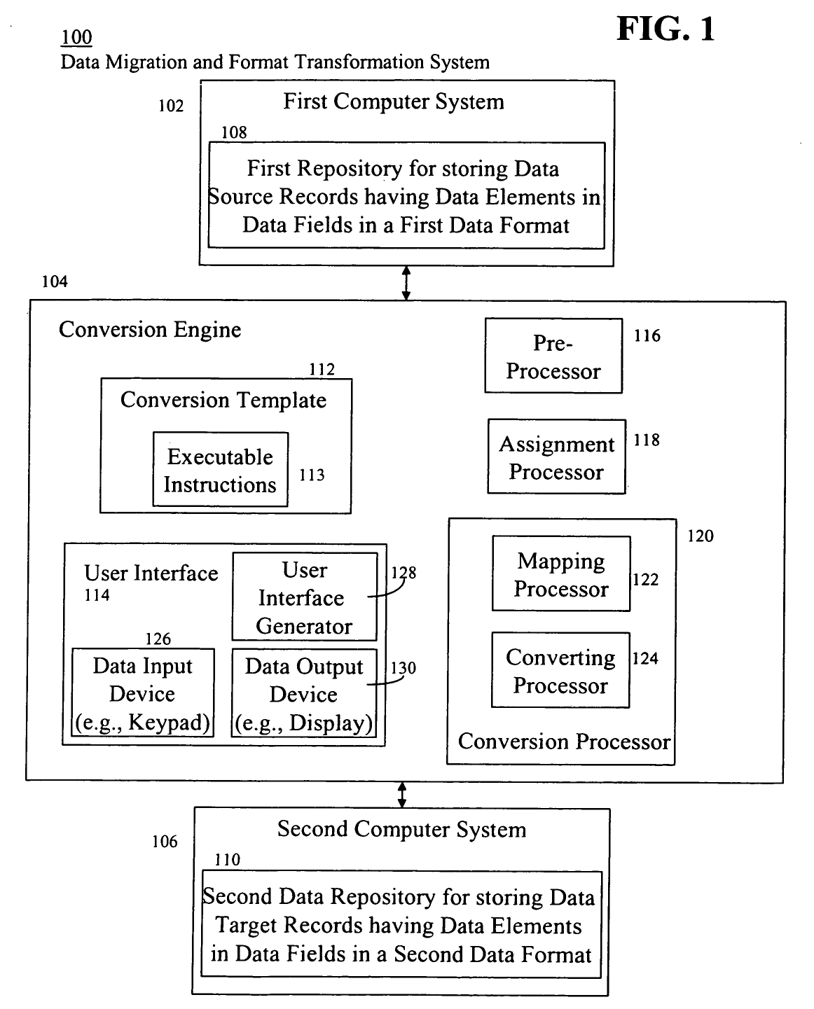

FIG. 1 illustrates a data migration and format transformation system 100 (hereinafter called “the system 100”). The system 100 generally includes a first computer system 102, a conversion engine 104, and a second computer system 106. The first computer system 102 includes a first repository 108 for storing data source records having data elements in data fields in a first data format. The second computer system 106 includes a second repository 110 for storing data target records having data elements in data fields in a second data format. Each of the first and second repositories may be any type of data storage device and may otherwise be called memory devices or databases. Each of the first computer system 102 including the first repository 108 and the second computer system 106 including the second repository 110, along with other computer related circuitry and associated software are well known to those skilled in the art.

The conversion engine 104 includes a conversion template 112, a user interface 114, a pre-processor 116, an assignment processor 118, and a conversion processor 120. The conversion template includes executable instructions 113. The user interface 114 includes a data input device 126, a user interface generator 128, and a data output device 130. The conversion processor includes a mapping processor 122 and a converting processor 124.

The system 100 is intended for use by a healthcare provider that is responsible for servicing the health and/or welfare of people in its care. A healthcare provider may provide services directed to the mental, emotional, or physical well being of a patient. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Preferably, the healthcare provider is a hospital. When servicing a person in its care, a healthcare provider diagnoses a condition or disease, and recommends a course of treatment to cure the condition, if such treatment exists, or provides preventative healthcare services. Examples of the people being serviced by a healthcare provider include, without limitation, a patient, a resident, a client, a user, and an individual.

The computer systems 102 and 106 each provide an electronic mechanism for a healthcare provider (otherwise called a “healthcare worker”) to access healthcare data. Each of the computer systems 102 and 106 may be fixed or mobile (i.e., portable), and may be implemented in a variety of forms including, without limitation, a desktop computer, a laptop computer, a workstation, a network-based device, a personal digital assistant (PDA), a smart card, a cellular telephone, a pager, and a wristwatch. Each of the computer systems 102 and 106 may be implemented in a centralized or decentralized configuration.

The user interface 114 includes the data input device 126 that permits a user to input information into the conversion engine 104 and the data output device 130 that permits a user to receive information from the conversion engine 104. Preferably, the data input device 126 is a keyboard, but also may be a touch screen, or a microphone with a voice recognition program, for example. Preferably, the data output device 130 is a display, but also may be a speaker, for example. The data output device 130 provides information to the user in response to the data input device 126 receiving information from a user or in response to other activity by the conversion engine 104. For example, the display presents information in response to a user entering information in the conversion engine 104 via the keyboard.

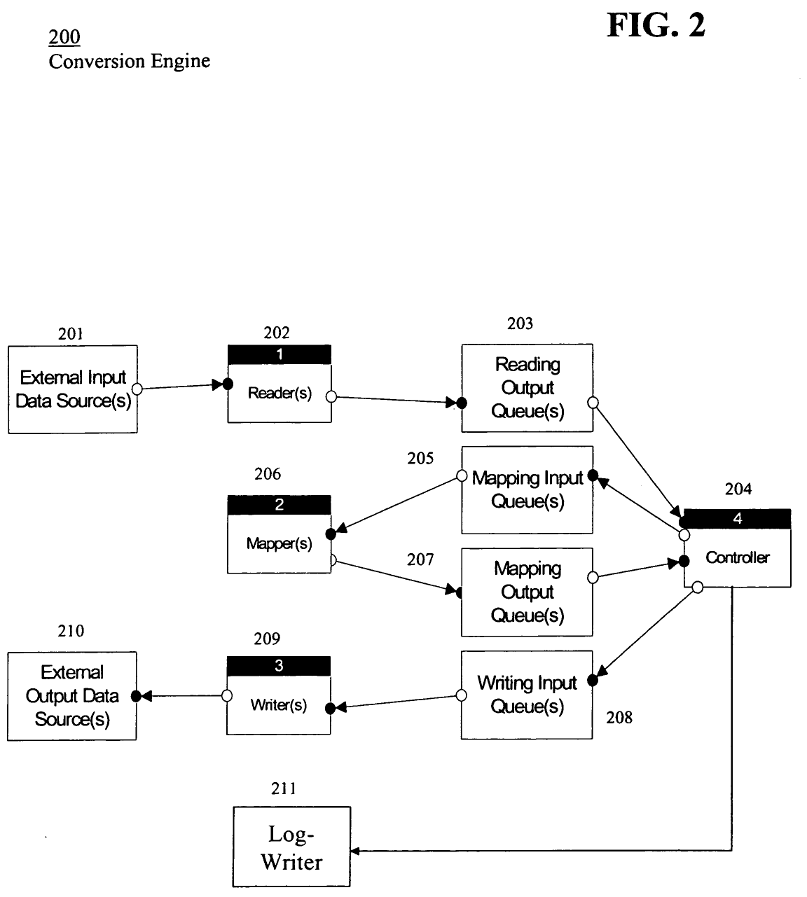

The user interface generator 128 generates information, preferably in the form of display images, for the data output device 130. A user interface processor or generator is a known element comprising electronic circuitry or software or a combination of both for generating display images or portions thereof. A user interface comprises one or more display images enabling user interaction with a processor or other device. Further, any of the functions provided by the system 100 and engine 104 of FIGS. 1 and 2, respectively, may be implemented in hardware, software, or a combination of both.

The user interface 114 preferably provides a graphical user interface (GUI), wherein at least portions of the data input device 126 and at least portions of the data output device 130 are integrated together to provide a user-friendly interface. For example, a web browser forms a part of each of the input device and the output device by permitting information to be entered into the web browser and by permitting information to be displayed by the web browser.

The conversion engine 104 communicates with the each of the computer systems 102 and 106 over a wired or wireless communication path. The term “path” may otherwise be called a network, a link, a channel, or a connection. The communication path may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and an Health Level Seven (HL7) protocol.

The healthcare information is generated, originated, or sourced by one or more various departments, otherwise called healthcare sources within one or both computer systems 102 and 106. Examples of the healthcare sources include, without limitation, a hospital system, a medical system, and a physician system, a records system, a radiology system, an accounting system, a billing system, and any other system required or desired in the system 100. The hospital system further includes, without limitation, a lab system, a pharmacy system, a financial system, and a nursing system. The medical system, otherwise called an enterprise, represents a healthcare clinic or another hospital system. The physician system represents a physician's office.

The healthcare information may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

In the conversion engine 104, one or more elements, as shown and described herein, may include one or more processors, such as the pre-processor 116, the assignment processor 118, and the conversion processor 124. As used herein, a processor comprises any one or combination of hardware, firmware, and/or software. A processor acts upon stored and/or received information by manipulating, analyzing, modifying, converting, or transmitting information for use by an executable procedure or an information device, and/or by routing the information to an output device. A processor may use or comprise the capabilities of a controller or microprocessor, for example.

A processor performs tasks in response to processing an object. An object, as used herein, comprises a grouping of data and/or executable instructions, an executable procedure, or an executable application. An executable application, as used herein, comprises code or machine readable instruction for implementing predetermined functions including those of an operating system, healthcare information system or other information processing system, for example, in response user command or input. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters.

The system 100 advantageously provides a flexible and customizable way to migrate complex data from one location (e.g., computer system 102 and/or data repository 108) to another (e.g., computer system 106 and/or data repository 110). The system 100 permits users, via the graphical user interface 114, to create and define conversion templates that specify how complex data moves from one location to another. Preferably, the system 100 facilitates migration of data from clinical electronic medical record systems to a different clinical executable application.

The conversion engine 104 enables creation of model conversion templates (otherwise called “plans”) that support common conversion tasks. The conversion templates 112 are customizable via the graphical user interface 114 to handle specific requirements. In response to testing of a conversion template 112, a user employs the graphical user interface 114 to modify the conversion template 112 to fix problems identified without requiring creation of executable software code. The conversion template 112 comprises predetermined instruction 113 directing a conversion process and is implemented in XML or other software program code language, for example.

The processors 116, 118, and 120 receive a conversion template 112 that defines the source data, target data, and mapping, and uses that conversion template 112 to move data from one location to another. The graphical user interface 114 allows end users to create, modify, and execute conversion templates 112.

According to a first aspect of the present invention, the system 100 transforms data of a first data structure to a different second data structure compatible with an executable application. The conversion template 112 includes one or more predetermined executable instructions 113 for directing conversion of data source records, stored in a first repository 108, from a first data format to data target records, stored in a second repository 110, having a different second data format. The conversion processor 120 maps 122 and converts 124 data elements in data fields of the source records to data elements in corresponding data fields of the target records by manipulating data element values and data field characteristics, in response to the conversion template 112.

The conversion template 112 associates an executable procedure with an individual record. The executable procedure is executed by the conversion processor 120 in mapping and converting data elements of the individual record for storage in corresponding data fields of a target record.

The pre-processor 116, validating the conversion template 112, provides a valid transformation process and initiates generation of a message identifying an invalid condition in response to a validation failure.

The conversion processor 120 maps and converts data elements in data fields of the source records to data elements in corresponding data fields of the target records using at least one of, (a) an attribute identifying a source record field data element is to be mapped to an identified target record data field, and (b) a source record data field attribute identifying a source record data field data element is to be assigned a data type different to a type of the source record data field data element.

The mapping processor 122 identifies a destination data field of a target data record for containing a data element of the second data format provided by conversion of a data element of the first data format of the source data record by the conversion processor 120.

According to a second aspect of the present invention, the system 100 transforms data of a first data structure to a different second data structure compatible with an executable application. The system 100 includes the assignment processor 118 and the conversion processor 120. The assignment processor 118 associates an executable procedure with at least one of, (a) a data record, and (b) a data field of a record of a plurality of data source records. The conversion processor 120 maps 122 and converts 124 data elements in data fields of the source data records having a first data format to data elements in data fields of target data records having a different second data format using the associated executable procedure.

The conversion template 112 comprises predetermined executable instruction 113 for directing mapping and converting of the data elements.

The system 100 directs the executable procedure to be performed at least one of, (a) prior to the conversion processor 120 performing the mapping, and (b) after the conversion processor 120 performs the mapping.

The user interface generator 128 initiates display of an image enabling a user to select an executable procedure to be associated with the at least one of, (a) a data record, and (b) a data field of a record of a plurality of data source records. The user interface generator 128 initiates display of an image enabling a user to select properties of an executable procedure to be associated with one or more of, (a) a data record, and (b) a data field of a record of a plurality of data source records. The user interface generator 128 further initiates display of an image enabling a user to select an individual executable procedure to be associated with a data segment comprising one or more of: (a) an individual data record, and (b) an individual data field of a record of a plurality of data source records, and the executable procedure is employed in converting data of the data segment of a first data format to a different second data format. The executable procedure also is employed in mapping data of the source record data segment to a target record data segment.

The assignment processor 118 replicates the executable procedure and associates the replicated executable procedure with one or more of: (a) a data record, and (b) a data field of a record of a plurality of data source records.

The conversion processor 120 maps 122 and converts 124 data elements in data fields of the source records to data elements in corresponding data fields of the target records using one or more of: (a) an attribute identifying a source record field, (b) a target record data field, (c) a function to be performed prior to the mapping, (d) a function to be performed after the mapping, (e) a source record type, (f) a target record type, and (g) an action to be performed, in response to detection of an error occurring during conversion. The conversion processor 120 maps 122 and converts 124 the data elements using an associated executable procedure by manipulating data element values and data field characteristics.

According to a third aspect of the present invention, the system 100 transforms data of a first data structure to a different second data structure compatible with an executable application. The system 100 includes the user interface generator 128 and the conversion processor 120. The user interface generator 128 initiates display of an image enabling a user to select an individual executable procedure to be associated with a data segment comprising one or more of: (a) an individual data record, and (b) an individual data field of a record of a plurality of data source records. The conversion processor 120 maps 122 and converts 124 data elements in the data segment, having a first data format, to data elements in a data segment of target data records, having a different second data format, using the associated executable procedure.

FIG. 2 illustrates a functional block diagram of the conversion engine 104, for the system shown in FIG. 1. The functional blocks of the conversion engine 104 in FIG. 2 perform the same functions as the conceptual blocks of the conversion engine 104 in FIG. 1.

The conversion engine 104 processes conversion templates 112 in four phases:

1. Validation—Insures that the conversion template 112 defines a valid data movement specification.

2. Pre-Processing—Initializes data structures and data source connections.

3. Execution—Moves data from one location to another.

4. Post-Processing—Cleans up data structures and data source connections.

The execution phase, detailed in FIG. 2, is where the main work is performed and is divided un into the following functions:

1. Reading—One or more engine readers 202 bring data from a source system 102 (FIG. 1) into the engine internal queues.

2. Mapping—One or more engine mappers 206 creates one or more output records from each record populated by the reader.

3. Writing—One or more engine writers 209 move data from the engine internal queues to the target system 106 (FIG. 1).

4. Log-Writer—One or more engine log-writers log data errors/warnings from processed records.

Engine processors perform the above engine functions. An engine processor is a module that implements a specific conversion engine interface and performs a specific function. The following list outlines the processor types:

1. Reader—Reads data from a data source and moves it into the engine internal queues.

2. Mapper—Creates output records from input records.

3. Writer—Moves data from engine internal queues to target data sources.

4. Field Valuator—Validates and manipulates field values.

5. Record Valuator—Validates and manipulates fields contained within a record.

6. Log-writer—Records and writes and data errors and/or warnings for a data record processed by the conversion engine 104. This processor is optional if a conversion does not need to process errors/warnings.

A main component of the conversion engine 104 is the controller 204. The controller 204 directs records from one processors' output queue to another processors' input-queue. A sequential flow of the functional block diagram of the conversion engine 104 begins with the external input data source(s) 201, to the reader(s) 202, to the reading output queue(s) 203, to the controller 204, to the mapping input queue(s) 205, to the mapper(s) 206, to the mapping output queue(s) 207, back to the controller 204, to the writing input queue(s) 208, to the writer(s) 209, and to the external output data source(s) 210. The controller 204 writes data errors/warnings produced from processing a record to the log-writer 211.

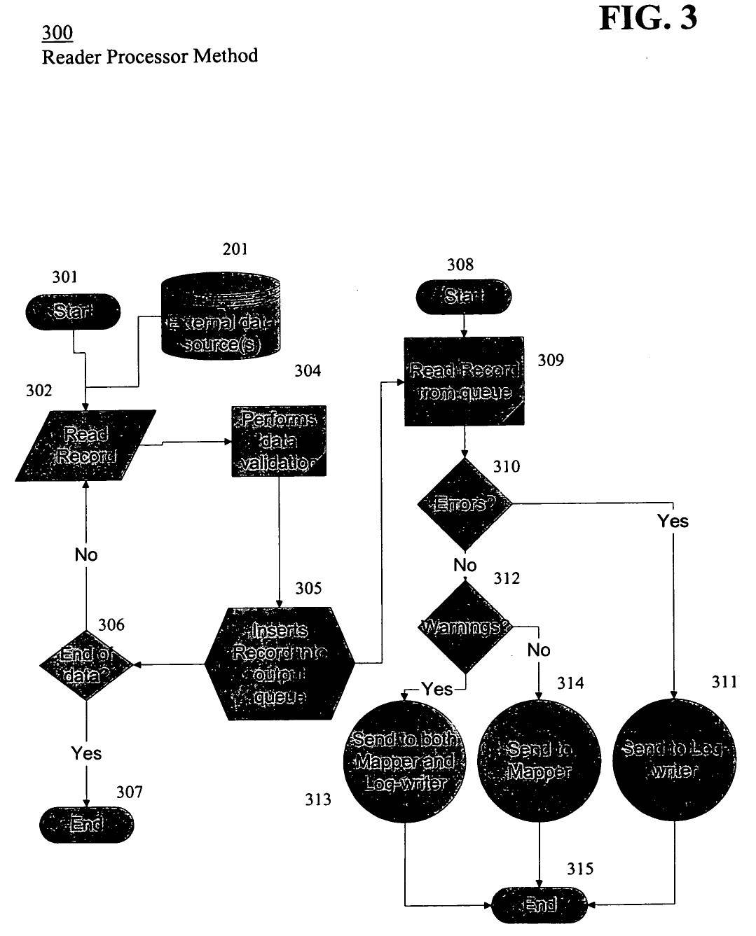

FIG. 3 illustrates a reader processor method 300, for the system 100 and engine. 104 shown in FIGS. 1 and 2, respectively. FIG. 3 shows a flow chart outlining the logic flow of the reader processor 202, as shown in FIG. 3. The left half of the flow chart (shown as steps 301-307) outlines the logic the reader processor 202 performs to read records from its assigned data source(s), load the data into the engines record objects and then insert the records into its output queue. The right half of the flow chart (shown as steps 308-315) outlines the logic taken by the controller 204 as it processes the records loaded into memory by the reader processor 202. Hence, each side of the flow chart represents separate threads of execution.

At step 301, the method 300 starts the left half of the flow chart.

At step 302, the method 300 reads a data record from the external input data source(s) 201, such as the first repository 108 (FIG. 1).

At step 304, the method 300 validates the data record.

At step 305, the method 300 inserts the data record into the output queue.

At step 306, the method 300 determines whether the appropriate data records have been read. If the determination at step 302 is positive then the method 300 continues to step 307; otherwise, if the determination at step 302 is negative, then the method 300 returns to step 302.

At step 307, the method 300 ends the left half of the flow chart in response to step 306.

At step 308, the method 300 starts the right half of the flow chart.

At step 309, the method 300 reads a data record from the output queue.

At step 310, the method 300 determines whether there are any errors in the data record. If the determination at step 310 is positive then the method 300 continues to step 311; otherwise, if the determination is negative, then the method 300 continues to step 312.

At step 311, the method 300 sends an error message to the log-writer 211 (FIG. 2) in response to step 310.

At step 312, the method 300 determines whether there are any warnings related to the data record in response to step 310. If the determination at step 312 is positive then the method 300 continues to step 313; otherwise, if the determination at step 312 is negative, then the method 300 continues to step 314.

At step 313, the method 300 sends the data record to the mapper 206 and sends the warning to the log-writer 211 in response to step 312.

At step 314, the method 300 sends the data record to the mapper 206 in response to step 312.

At step 315, the method 300 ends the right half of the flow chart in response to one of steps 311, 313, and 314.

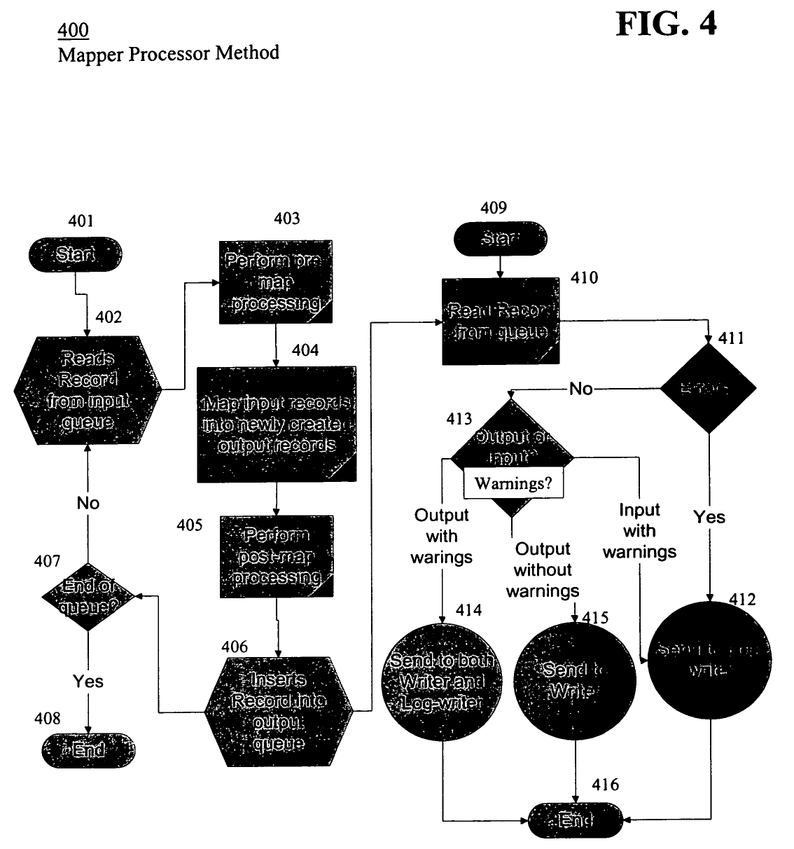

FIG. 4 illustrates a mapper processor method 400, for the system 100 and engine 104 shown in FIGS. 1 and 2, respectively. FIG. 4 shows a flow chart outlining the logic flow of the mapper processor 206, as shown in FIG. 2. The left half of the flow chart (shown as steps 401-408) outlines the logic the mapper 206 performs to read records from its assigned input queue, create new output records, and then insert the records into its output queue. The right half of the flow chart (shown as steps 409-417) outlines the logic taken by the controller 204 as it processes the records created by the mapper 206. Hence, each side of the flow chart represents separate threads of execution.

At step 401, the method 400 starts the left half of the flow chart.

At step 402, the method 400 reads a data record from the input queue.

At step 403, the method 400 performs pre-mapping processing.

At step 404, the method 400 maps input data records into newly created output data records.

At step 405, the method 400 performs post-mapping processing.

At step 406, the method 400 inserts the data record into the output queue.

At step 407, the method 400 determines whether the mapper processor 206 has reached the end of the input queue (i.e., read the appropriate data records). If the determination at step 407 is positive then the method 400 continues to step 408; otherwise, if the determination at step 407 is negative, then the method 400 returns to step 402.

At step 408, the method 400 ends the left half of the flow chart in response to step 407.

At step 409, the method 400 starts the right half of the flow chart.

At step 410, the method 400 reads a data record from the output queue.

At step 411, the method 400 determines whether the data record has errors. If the determination at step 411 is positive then the method 400 continues to step 412; otherwise, if the determination at step 411 is negative, then the method 400 continues to step 413.

At step 412, the method 400 sends the errors in the data record to the log-writer 211 in response to step 411.

At step 413, the method 400 determines whether there are warnings related to the data record read from the input queue or provided to the output queue in response to step 411. If the determination at step 413 is that there are any warnings related to the data record read from the input queue, then the method 400 continues to step 412. If the determination at step 413 is that there are any warnings related to the data record read from the output queue, then the method 400 continues to step 414. If the determination at step 413 is that there are no warnings related to the data record read from the output queue, then the method 400 continues to step 415.

At step 414, the method 400 sends the data record to the writer 209 and the log-writer 211 in response to step 413.

At step 415, the method 400 sends the data record to the writer 209 in response to step 413.

At step 416, the method 400 ends the right half of the flow chart in response to one of steps 412, 414, and 415.

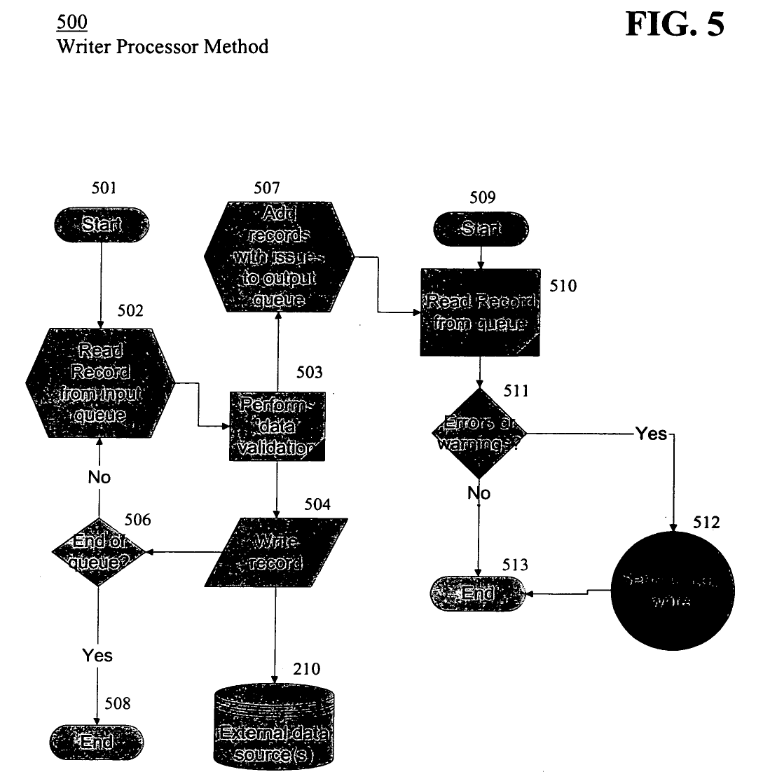

FIG. 5 illustrates a writer processor method 500, for the system 100 and engine 104 shown in FIGS. 1 and 2, respectively. FIG. 5 shows a flow chart outlining the logic flow of the writer processor 209. The left half of the flow chart (shown as steps 501-508) outlines the logic the writer 209 performs to read records from its assigned input queue, write records to its assigned data source(s), and then insert any problem records into its output queue. The right half of the flow chart (shown as steps 509-513) outlines the logic taken by the controller 204 as it processes the records created by the writer. Hence, each side of the flow chart represents separate threads of execution.

At step 501, the method 500 starts the left half of the flow chart.

At step 502, the method 500 reads a data record from the input queue.

At step 503, the method 500 validates the data record.

At step 504, the method 500 writes a data record to the external output data source(s) 210 (FIG. 2), such as the second repository 110 (FIG. 1), in response to a positive validation at step 503.

At step 506, the method 500 determines whether the writer has reached the end of the input queue (i.e., read the appropriate data records). If the determination at step 506 is positive then the method 500 continues to step 508; otherwise, if the determination at step 506 is negative, then the method 500 returns to step 502.

At step 507, the method 500 adds data records with issues (e.g., errors or warnings) to the output queue in response to a negative validation at step 503.

At step 508, the method 500 ends the left half of the flow chart in response to step 506.

At step 509, the method 500 starts the right half of the flow chart.

At step 510, the method 500 reads a data record from the output queue.

At step 511, the method 500 determines whether there are any errors or warnings related to the data record in response to step 510. If the determination at step 511 is positive then the method 500 continues to step 512; otherwise, if the determination at step 511 is negative, then the method 500 continues to step 513.

At step 512, the method 500 sends errors or warnings related to the data record to the log-writer 211 (FIG. 2) in response to step 511.

At step 513, the method 500 ends the right half of the flow chart in response to one of steps 511 and 512.

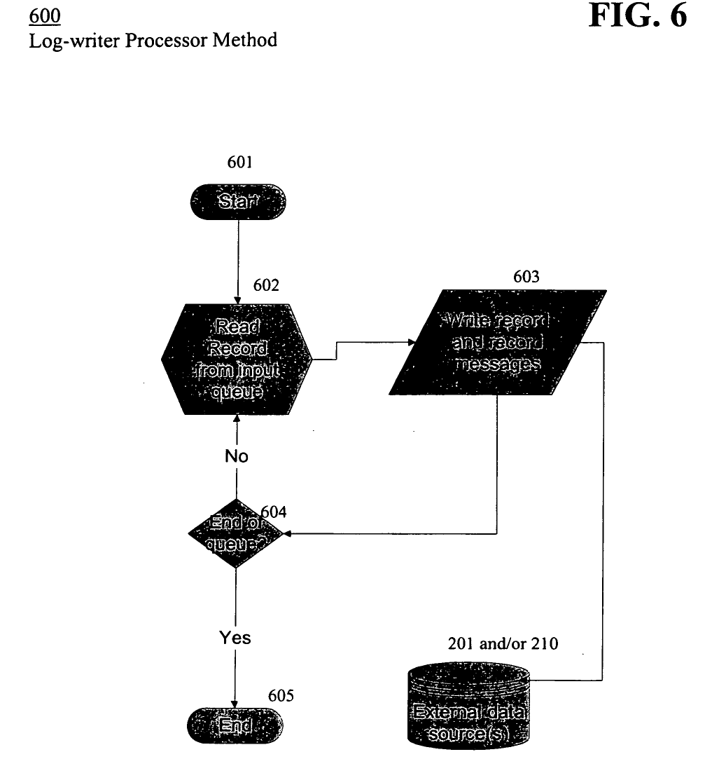

FIG. 6 illustrates a log-writer processor method 600, for the system 100 and engine 104 shown in FIGS. 1 and 2, respectively. FIG. 6 shows a flow chart outlining the logic flow of the log-writer processor 211 (FIG. 2). The flow chart outlines the logic the log-writer 211 performs to read records from its assigned input queue, write errors/warnings and any pertinent data from the record to its assigned data source(s).

At step 601, the method 600 starts.

At step 602, the method 600 reads a data record from the input queue of the log-writer 211.

At step 603, the method 600 writes the data record and any messages (e.g., errors or warnings) associated with the data records to the external data sources 201 and/or 210.

At step 604, the method 600 determines whether the log-writer 211 has reached the end of the input queue (i.e., read the appropriate data records). If the determination at step 604 is positive, then the method 600 continues to step 605; otherwise, if the determination at step 604 is negative, then the method 600 returns to step 602.

At step 605, the method 600 ends.

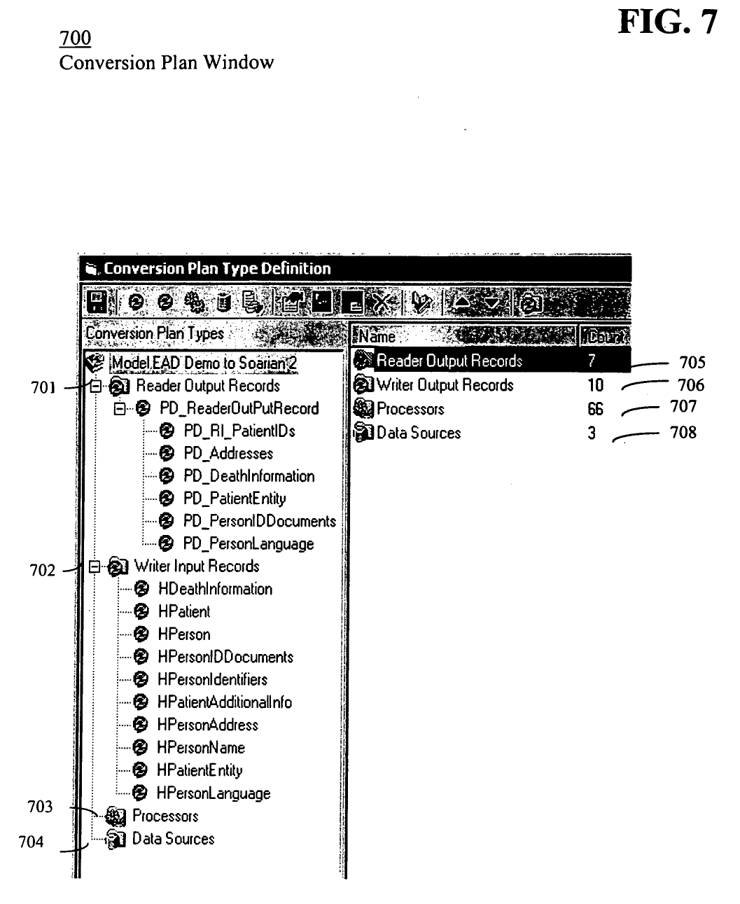

FIGS. 7-14 illustrate examples of user interface windows that are provided to implement the user interface 114 in the conversion engine 104, as shown in FIG. 1. The graphical user interface (GUI) 114, shown in FIG. 1, allows plans to be developed that define how data is moved from one location to another.

FIG. 7 illustrates a conversion plan window 700, for the system 100 and engine 104 shown in FIGS. 1 and 2, respectively. To create a conversion plan, a user, such as a conversion plan developer, uses the conversion plan, type maintenance function to define the source records, target records, data mapping, and plan options. FIG. 7 shows an overview of a conversion plan. The left side of the conversion plan window 700 shows the conversion plan types including the reader output records 701, the writer input records 702, the processors 703, and the data sources 704. The reader records 701 define what the reader processor(s) 202 (FIG. 2) load into memory from their assigned data source(s) 201 (represented as 704 in FIG. 7). The writer, records 702 define what records are created by the mapper processor(s) 206 and sent to the writer processor(s) 209. The writer processor(s) 209 sends the writer records created by the mapper 206 to their assigned data source(s) 210 (represented as 704 in FIG. 7). The right half of the conversion plan window 700 shows the number of reader output records 705, the number of writer output records 706, the number of processors 707, and the number of data sources 708.

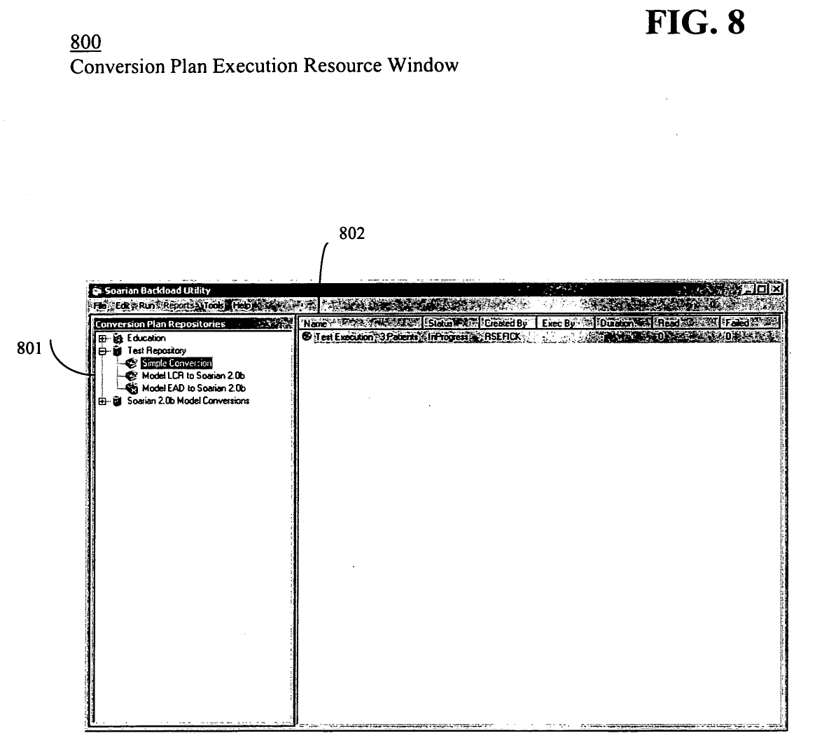

FIG. 8 illustrates a conversion plan execution resource window 800, for the system 100 and engine 104 shown in FIGS. 1 and 2, respectively. After a user creates the conversion template, the conversion plan execution resource window 800 uses the conversion engine GUI 114 to copy model conversion templates, set conversion template options, and run conversion templates. The left side of the conversion plan execution resource window 800 includes a conversion plan repositories window 800 that displays various conversion plans 801 that were created by the user. The conversion plan execution resource window 800 also displays the name of a conversion plan 802 along with associated details of the conversion plan, such as status, who the plan was created by, who executed the plan, the duration of the plan, how many records were read, how many records failed.

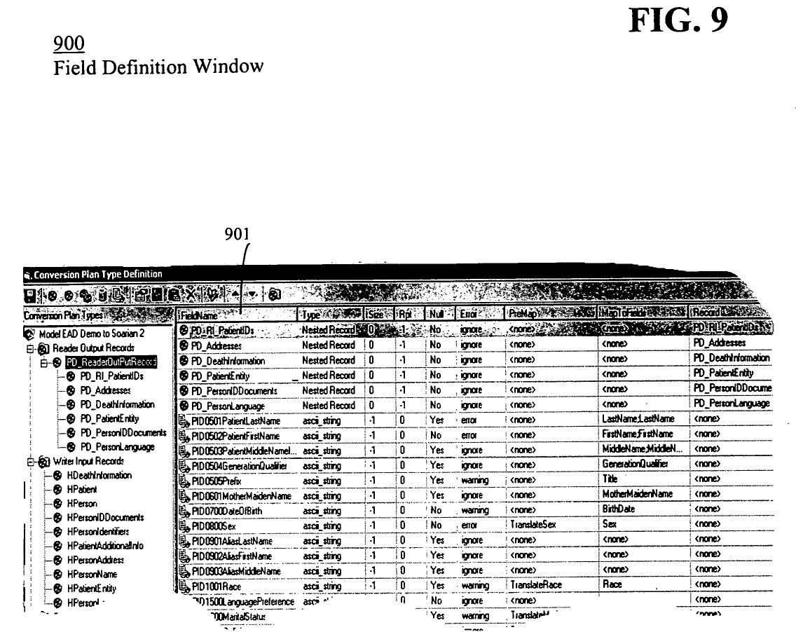

FIG. 9 illustrates a field definition window 900, for the system 100 and engine 104 shown in FIGS. 1 and 2, respectively. The left side of the field definition window 900 is the same as in FIG. 7. On the right side of the field definition window 900, each data record has a list of field definitions 901 that the plan user creates. Each field definition 901 is assigned various associated attributes such as data type, size (for variably repeating types), a fields' repeat value, null, error, pre-map, map-to-fields, record, etc . . . In particular, the map-to-fields (or map-from-fields for writer records) attribute defines to the mapper processor 206 how to transfer data within the reader record to the writer record. A beneficial feature of the field definition window 900 is the ability for a field to be assigned a type of another record. This gives the plan user the ability to define hierarchical data definitions.

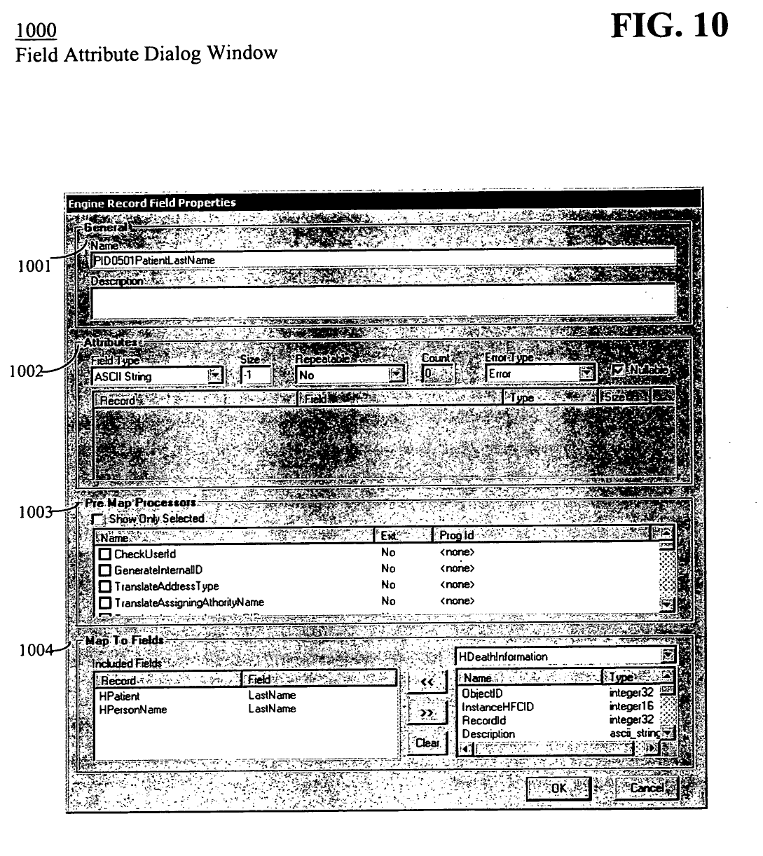

FIG. 10 illustrates a field attribute window 1000, for the system 100 and engine 104 shown in FIGS. 1 and 2, respectively. A user uses the field attribute window 1000 to edit the field attributes shown in FIG. 9. The user is permitted to edit fields including, without limitation, a general field 1001, attributes 1002, pre-map processors 1003, and map to fields 1004. The general field 1001 includes, for example, the name of the field definitions 901 and an associated description. The attributes 1002 include, for example, the field type, the size, whether or not the field is repeatable, the count, the error type, and whether the field is nullable. The pre map processors 1003 include, for example, ChedkUser Id, GenerateInternalID, TranslateAddressType, TranslateAssigningAuthorityName. The map to fields 1004 include, for example, record identifier (e.g., Hpatient) and field (LastName), and fields described by name (e.g., ObjectID) and type (integer32).

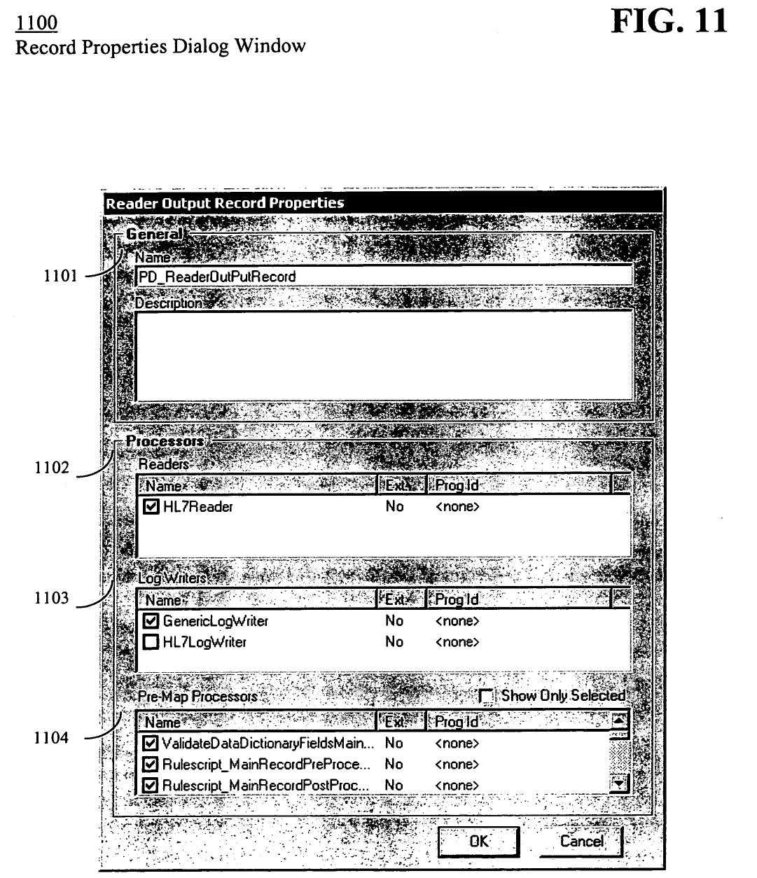

FIG. 11 illustrates a record properties dialog window 1100, for the system 100 and engine 104 shown in FIGS. 1 and 2, respectively. The processors list allows the assignment of processors to a field so that the data in the field can be processed before mapping, if the field is within a reader record, or after mapping, if the field is within a writer record. Processors can also be assigned at the record level. This is done with the record properties dialog window 1100. The record properties dialog window 1100 includes, without limitation, a general field 1101, and a processors field 1102. The general field 1101 includes, for example, a name (e.g., PD_ReaderOutPutRecord) and an associated description. The processors field 1102 includes, for example, readers, log-writers 1103, and pre-map processors 1104, each of which is further described by a name, an extension, and a program ID.

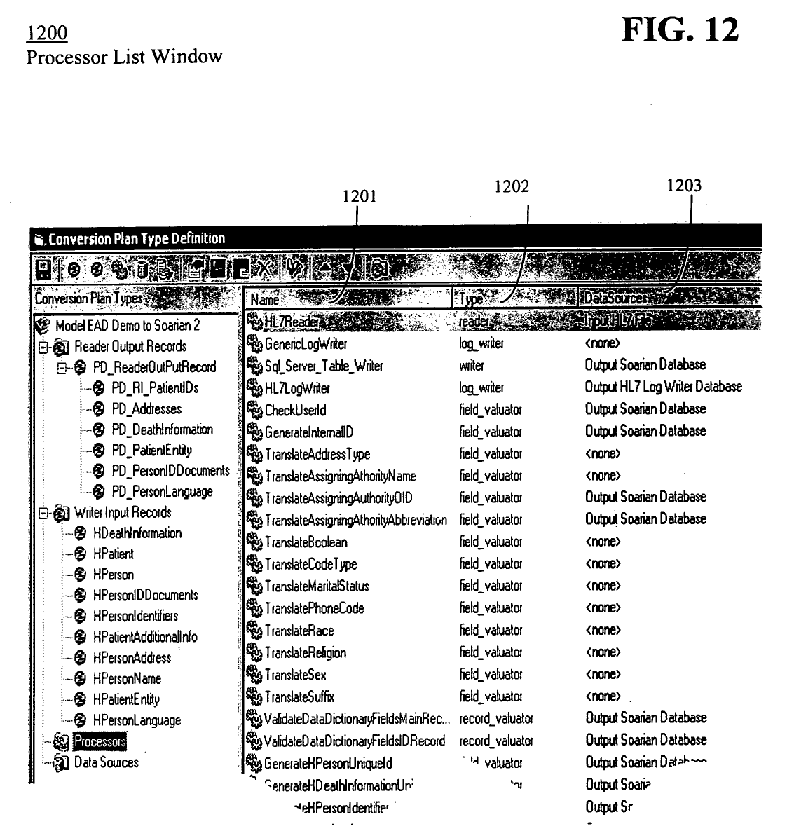

FIG. 12 illustrates a processor list window 1200, for the system 100 and engine 104 shown in FIGS. 1 and 2, respectively. The processor list window 1200 is also used to define what readers, log-writers, and writers are used to process a particular data record. Although the windows in FIGS. 10 and 11 are used to assign established processor instances to fields/records, the processor instances are first created within the plan. The left side of the processor list window 1200 is the same as in FIG. 7. The right side of the processor list window 1200, shows an example a conversion plans' processor list. Each processor list includes, for example, a name 1201 (e.g., HL7Reader), a type 1202 (e.g., reader), and a data source 1203 (e.g., input HL7 File)

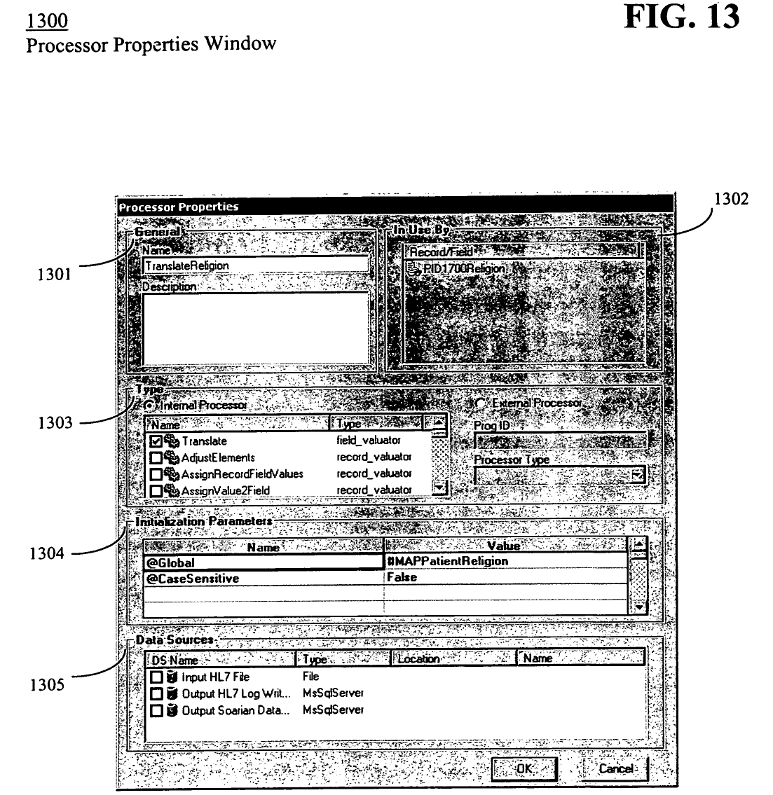

FIG. 13 illustrates a processor properties window 1300, for the system 100 and engine 104 shown in FIGS. 1 and 2, respectively. A user creates and/or modifies processors using the processor properties window 1300. The processor properties window 1300 includes, without limitation, the following fields: general 1301, “in use by” 1302, type 1303, initialization parameters 1304, and data sources 1305. The general field 1301 includes, for example, a name (e.g., TranslateReligion), and an associated description. The “in use by” field 1302 includes, for example, a record/field (e.g., PID1700Religion). The type field 1303 includes, for example, an internal processor selection and an external processor selection, a name and type of the processor, a program ID, and a processor type selection. The initialization parameters field 1304 includes, for example, a name (e.g., @Global), and a value (e.g., #MAPPatientReligion). The data sources field 1305 includes, for example, a data source name (e.g., Input HL7 File), and an associated type, (e.g., file), location, and name.

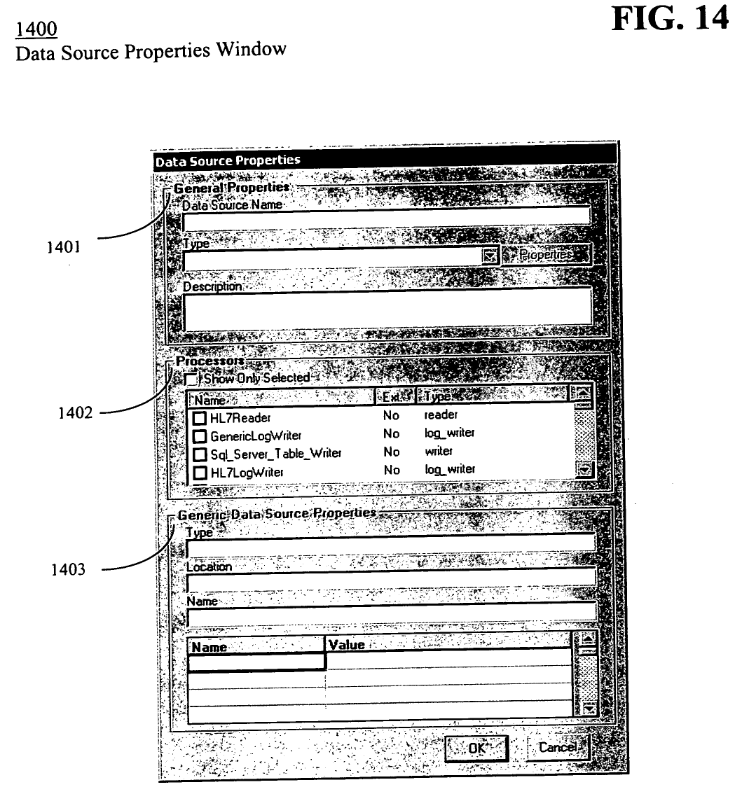

FIG. 14 illustrates a data source properties window 1400, for the system 100 and engine 104 shown in FIGS. 1 and 2, respectively. A user can create multiple instances of processor types to perform the same tasks, but with different parameters for performing the processors tasks. A user can also assign data sources to a processor, after the data source is created, using the data source properties window 1400. Therefore, at the time a user creates the data source, the user can assign the data source to an already created processor (as opposed to doing the assignment within the processor properties dialog). A user can add and/or modify data sources using the data source properties window 1400. The data source properties window 1400 includes, without limitation, the following fields: general properties 1401, processors 1402, and generic data source properties 1403. The general properties field 1401 includes, for example, a data source name, and an associated type and description. The processor field 1402 includes for example, a name (e.g., HL7Reader), and an associated extension and type. The generic data source properties field 1403 includes, for example, a type, a location, a name, and a name with an associated value.

The system 100 advantageously provides, for example:

1. Segmenting data processing into processors. This allows the conversion engine infrastructure to be left in tact while new processors are defined to handle specific conversion needs.

2. Employing record and field valuers to provide flexible ways to manipulate field values before they are moved to their final location.

3. Associating rule scripts with records to perform complex data movement tasks without writing C++ code.

4. Supporting efficient data movement (such as SQL Server BCP) to insure efficient processing.

5. Facilitating conversion tasks customization by changing conversion settings. For conversions that are more complex, the GUI 114 is used to enable user customization of a conversion process.

The conversion engine 104 provides a flexible and customizable way to migrate complex data from one location to another. The conversion engine 104 allows conversion templates 112 to be developed that describe source data 108, target data 110, and the mapping 120 to migrate data from the source 108 to the target 110. The conversion engine 104 also allows processors and custom rules to be assigned in the conversion template 112 to allow data to be manipulated as it moves from one location to another. The conversion engine 104 is geared towards mass data movement and uses an efficient mechanism to speed up transfer of data from one location to another.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for transforming data of a first data structure to a different second data structure compatible with an executable application, comprising:
a conversion template comprising predetermined executable instruction for directing conversion of data source records from a first data format to data target records having a different second data format;
a conversion processor for mapping and converting data elements in data fields of said source records to data elements in corresponding data fields of said target records by manipulating data element values and data field characteristics, in response to said conversion template.

2. The system according to claim 1, wherein
said conversion template associates an executable procedure with an individual record and said executable procedure is executed by said conversion processor in mapping and converting data elements of said individual record for storage in corresponding data fields of a target record.

3. The system according to claim 1, including
a pre-processor for validating said conversion template provides a valid transformation process and initiating generation of a message identifying an invalid condition in response to a validation failure.

4. The system according to claim 1, wherein
said conversion processor maps and converts data elements in data fields of said source records to data elements in corresponding data fields of said target records using at least one of, (a) an attribute identifying a source record field data element is to be mapped to an identified target record data field and (b) a source record data field attribute identifying a source record data field data element is to be assigned a data type different to a type of said source record data field data element.

5. The system according to claim 1, including
a mapping processor for identifying a destination data field of a target data record for containing a data element of said second data format provided by conversion of a data element of said first data format of said source data record by said conversion processor.

6. A system for transforming data of a first data structure to a different second data structure compatible with an executable application, comprising:
an assignment processor for associating an executable procedure with at least one of, (a) a data record and (b) a data field of a record of a plurality of data source records;
a conversion processor for mapping and converting data elements in data fields of said source data records having a first data format to data elements in data fields of target data records having a different second data format using said associated executable procedure.

7. The system according to claim 6, including
a conversion template comprising predetermined executable instruction for directing mapping and converting of said data elements.

8. The system according to claim 6, wherein
said system directs said executable procedure is performed at least one of, (a) prior to said conversion processor performing said mapping and (b) after said conversion processor performs said mapping.

9. The system according to claim 6, including
a user interface generator for initiating display of an image enabling a user to select an executable procedure to be associated with said at least one of, (a) a data record and (b) a data field of a record of a plurality of data source records

10. The system according to claim 6, including
a user interface generator for initiating display of an image enabling a user to select properties of an executable procedure to be associated with said at least one of, (a) a data record and (b) a data field of a record of a plurality of data source records

11. The system according to claim 6, including
a user interface generator for initiating display of an image enabling a user to select an individual executable procedure to be associated with a data segment comprising at least one of, (a) an individual data record and (b) an individual data field of a record of a plurality of data source records, and said executable procedure is employed in converting data of said data segment of a first data format to a different second data format.

12. The system according to claim 6, including
a user interface generator for initiating display of an image enabling a user to select an individual executable procedure to be associated with a data segment comprising at least one of, (a) an individual data record and (b) an individual data field of a record of a plurality of data source records, and said executable procedure is employed in mapping data of said source record data segment to a target record data segment.

13. The system according to claim 6, wherein
said assignment processor replicates said executable procedure and associates said replicated executable procedure with said at least one of, (a) a data record and (b) a data field of a record of a plurality of data source records.

14. The system according to claim 6, wherein
said conversion processor maps and converts data elements in data fields of said source records to data elements in corresponding data fields of said target records using at least one of, (a) an attribute identifying a source record field, (b) a target record data field, (c) a function to be performed prior to said mapping, (d) a function to be performed after said mapping, (e) a source record type, (f) a target record type and (g) an action to be performed in response to detection of an error occurring during conversion.

15. The system according to claim 6, wherein
said conversion processor maps and converts said data elements using said associated executable procedure by manipulating data element values and data field characteristics.

16. A system for transforming data of a first data structure to a different second data structure compatible with an executable application, comprising:
a user interface generator for initiating display of an image enabling a user to select an individual executable procedure to be associated with a data segment comprising at least one of, (a) an individual data record and (b) an individual data field of a record of a plurality of data source records; and
a conversion processor for mapping and converting data elements in said data segment having a first data format to data elements in a data segment of target data records having a different second data format using said associated executable procedure.
